(19) United States
(12) Patent Application Publication
(10) Pub. No.: US 2024/0179656 A1
(43) Pub. Date: May 30, 2024

(54) WIRELESS COMMUNICATION METHOD, TERMINAL DEVICE, AND NETWORK DEVICE

(71) Applicant: GUANGDONG OPPO MOBILE TELECOMMUNICATIONS CORP., LTD., Dongguan (CN)

(72) Inventors: Wenhong CHEN, Dongguan (CN); Zhihua SHI, Dongguan (CN)

(73) Assignee: GUANGDONG OPPO MOBILE TELECOMMUNICATIONS CORP., LTD., Dongguan (CN)

(21) Appl. No.: 18/434,344

(22) Filed: Feb. 6, 2024

Related U.S. Application Data
(63) Continuation of application No. PCT/CN2021/117184, filed on Sep. 8, 2021.

(51) Int. Cl. H04W 56/00; H04L 5/00

(52) U.S. Cl. CPC H04W 56/0045; H04L 5/0048

(57) ABSTRACT

A method for wireless communication includes: a terminal device determines a transmission timing of a target uplink signal according to a reference signal indicated in first information configured for the target uplink signal, the first information being a transmission configuration indicator (TCI) state or spatial relation information; and the terminal device transmits the target uplink signal according to the transmission timing of the target uplink signal.

### CROSS-REFERENCE TO RELATED APPLICATION

This application is a continuation of International Application No. PCT/CN2021/117184 filed on Sep. 8, 2021, the disclosure of which is hereby incorporated by reference in its entirety.

### BACKGROUND

In a new radio (NR) system, a terminal device receives, using different downlink timings, downlink signals transmitted by two transmission/reception points (TRPs) (if the two TRPs are not completely synchronized). Alternatively, respective propagation delays between the terminal device and the two TRPs may differ a lot, such that respective uplink transmission timings required between the terminal device and the two TRPs may also differ. In this case, there may be performance loss due to asynchronous timings with the TRPs (i.e., a synchronization error exceeding a cyclic prefix (CP) length) if the terminal device transmits uplink signals respectively to the two TRPs using identical uplink transmission timings. There is a pressing need for how a terminal device determines transmission timings of uplink signals sent respectively to different TRPs.

### SUMMARY

Embodiments of the disclosure relates to the field of communication, and particularly to a method for wireless communication, a terminal device, and a network device.

Embodiments of the disclosure provide a method for wireless communication, a terminal device, and a network device. The terminal device is allowed to determine different transmission timings for uplink signals to be transmitted to different TRPs, thereby supporting multi-TRP based uplink transmission in a non-synchronization or great transmission delay scene, guaranteeing synchronization of uplink signals transmitted to different TRPs between the TRPs and the terminal device, and avoiding performance loss.

In a first aspect, a method for wireless communication is provided. The method includes operations as follows.

A terminal device determines a transmission timing of a target uplink signal according to a reference signal indicated in first information configured for the target uplink signal. The first information is a transmission configuration indicator (TCI) state or spatial relation information.

The terminal device transmits the target uplink signal according to the transmission timing of the target uplink signal.

In a second aspect, a terminal device is provided that includes a processor, a memory and a transceiver. The memory is configured to store computer-executable instructions. The processor is configured to invoke and run the computer-executable instructions stored in the memory to perform operations of: determining a transmission timing of a target uplink signal according to a reference signal indicated in first information configured for the target uplink signal, the first information being a transmission configuration indicator (TCI) state or spatial relation information; and transmitting, through the transceiver, the target uplink signal according to the transmission timing of the target uplink signal.

In a third aspect, a network device is provided that includes a processor, a memory and a transceiver. The memory is configured to store computer-executable instructions. The processor is configured to invoke and run the computer-executable instructions stored in the memory to perform operations of: transmitting, through the transceiver, first information to a terminal device, wherein a reference signal indicated in the first information is configured to be used by the terminal device in determining a transmission timing of a target uplink signal, the first information being a transmission configuration indicator (TCI) state or spatial relation information; and receiving, through the transceiver, the target uplink signal transmitted by the terminal device according to the transmission timing of the target uplink signal.

### BRIEF DESCRIPTION OF THE DRAWINGS

FIG. 1 is a diagram of architecture of a communication system to which embodiments of the disclosure apply.

FIG. 2 is a diagram of uplink non-coherent transmission according to the disclosure.

FIG. 3 is a diagram of slot-based physical uplink shared channel (PUSCH) repetition according to the disclosure.

FIG. 4 is a diagram of multi-TRP/panel based PUSCH repetition according to the disclosure.

FIG. 5 is a diagram of slot-based physical uplink control channel (PUCCH) repetition according to the disclosure.

FIG. 6 is a diagram of multi-TRP/panel based PUCCH repetition according to the disclosure.

FIG. 7 is a flowchart of a method for wireless communication according to an embodiment of the disclosure.

FIG. 8 is a flowchart of another method for wireless communication according to an embodiment of the disclosure.

FIG. 9 is a block diagram of a terminal device according to an embodiment of the disclosure.

FIG. 10 is a block diagram of a network device according to an embodiment of the disclosure.

FIG. 11 is a block diagram of a communication device according to an embodiment of the disclosure.

FIG. 12 is a block diagram of an apparatus according to an embodiment of the disclosure.

FIG. 13 is a block diagram of a communication system according to an embodiment of the disclosure.

### DETAILED DESCRIPTION

A technical solution in embodiments of the disclosure is described hereinafter with reference to the drawings in embodiments of the disclosure. Clearly, embodiments illustrated herein are some, instead of all, embodiments according to the disclosure. Based on the embodiments of the disclosure, a person having ordinary skill in the art may acquire another embodiment without creative effort. Any such embodiment falls within the scope of the disclosure.

A technical solution according to embodiments of the disclosure may apply to various communication systems, such as a global system of mobile communication (GSM), a code division multiple access (CDMA) system, a wideband code division multiple access (WCDMA) system, a general packet radio service (GPRS), a long term evolution (LTE) system, an advanced long term evolution (LTE-A) system, a new radio (NR) system, an evolved NR system, a LTE-based access to unlicensed spectrum (LTE-U) system, a NR-based access to unlicensed spectrum (NR-U) system, a non-terrestrial networks (NTN) system, a universal mobile telecommunication system (UMTS), wireless local area networks (WLAN), wireless fidelity (WiFi), a 5th-generation (5G) system, or another communication system, etc.

In general, a conventional communication system supports a limited number of connections, which is also easy to achieve. However, with development of communication technology, in addition to supporting conventional communication, a mobile communication system also has to support device to device (D2D) communication, machine to machine (M2M) communication, machine type communication (MTC), vehicle to vehicle (V2V) communication, or vehicle to everything (V2X) communication, etc., for example. Embodiments of the disclosure may also apply to these communication systems.

In some embodiments, a communication system in embodiments of the disclosure may apply to a carrier aggregation (CA) scene, a dual connectivity (DC) scene, as well as a standalone (SA) networking scene.

In some embodiments, a communication system in embodiments of the disclosure may apply to an unlicensed spectrum. An unlicensed spectrum may also be deemed as a shared spectrum. Alternatively, a communication system in embodiments of the disclosure may also apply to a licensed spectrum. A licensed spectrum may also be deemed as an unshared spectrum.

Embodiments of the disclosure describe each embodiment with reference to a network device as well as a terminal device. A terminal device may also be referred to as a user equipment (UE), an access terminal, a user unit, a user station, a mobile station, a remote station, a remote terminal, a mobile device, a user terminal, a terminal, a wireless communication device, a user agent, or a user apparatus, etc.

A terminal device may be a station (ST) in WLAN, and may be a cell phone, a cordless phone, a session initiation protocol (SIP) phone, a wireless local loop (WLL) station, a personal digital assistant (PDA) device, a handheld device capable of radio communication, a computing device, or another processing device connected to a radio modem, an onboard device, a wearable device, a terminal device in a next-generation communication system such as a NR network, or a terminal device in a future evolved public land mobile network (PLMN), etc.

In embodiments of the disclosure, a terminal device may be deployed on land, such as indoor or outdoor, handheld, wearable, or onboard; on water (such as a ship, etc.); and may also be airborne such as onboard an aircraft, a balloon, a satellite, etc.

In embodiments of the disclosure, a terminal device may be a mobile phone, a pad, a computer with a wireless transceiving function, a virtual reality (VR) terminal device, an augmented reality (AR) terminal device, a wireless terminal device in industrial control, a wireless terminal device in self driving, a wireless terminal device in remote medical, a wireless terminal device in a smart grid, a wireless terminal device in transportation safety, a wireless terminal device in a smart city, or a wireless terminal device in a smart home, etc.

By way of example, but not limitation, in embodiments of the disclosure, the terminal device may further be a wearable equipment. A wearable equipment may also be referred to as a wearable smart equipment, and is a blanket term for wearable equipment developed by applying intelligent design to everyday wear using wearable technology, such as glasses, gloves, watches, clothing, shoes, etc. A wearable equipment is a portable equipment direct worn by a user, or integrated to clothes or an accessory of the user. A wearable equipment not only may be a hardware equipment, but also may implement a powerful function through software support, data exchange, cloud exchange, etc. A wearable smart equipment in general may include one with comprehensive functions, being large-sized, and implementing all or some of the functions independent of any smart mobile phone, such as a smart watch, smart glasses, etc., and one that focuses on just a certain application function and that has to be used together with another equipment such as a smart mobile phone, such as various smart bracelets, smart jewelry for monitoring a physical sign, etc.

In embodiments of the disclosure, a network device may be configured to communicate with a mobile device. A network device may be a transmission/reception point (TRP), an access point (AP) in WLAN, a base transceiver station (BTS) in GSM or CDMA, a node B (NB) in WCDMA, an evolutional node B (eNB or eNodeB) in LTE, or a relay or an AP, or an onboard device, a wearable device as well as a network device or a base station (next generation NodeB, gNB) in a NR network or a network device in a future evolved PLMN or a network device in an NTN network, etc.

By way of example, but not limitation, in embodiments of the disclosure, a network device may have mobile characteristics. For example, a network device may be a mobile device. In some embodiments, a network device may be a satellite, a balloon station, etc. For example, the satellite may be a low earth orbit (LEO) satellite, a medium earth orbit (MEO) satellite, a geostationary earth orbit (GEO) satellite, a high elliptical orbit (HEO) satellite, etc. In some embodiments, a network device may further be a BTS provided at a location such as on land, on water, etc.

In embodiments of the disclosure, a network device may provide a cell with a service. A terminal device may perform communication with the network device through a transmission resource used in the cell (such as the frequency resource, or a spectrum resource). The cell may be a cell corresponding to the network device (such as a BTS). The cell may belong to a macro BTS, or to a BTS corresponding to a small cell. Here, a small cell may include a metro cell, a micro cell, a pico cell, a femto cell, etc. Such a small cell may have a small coverage and a low transmit power, and be suitable for providing a data transmission service of a high rate.

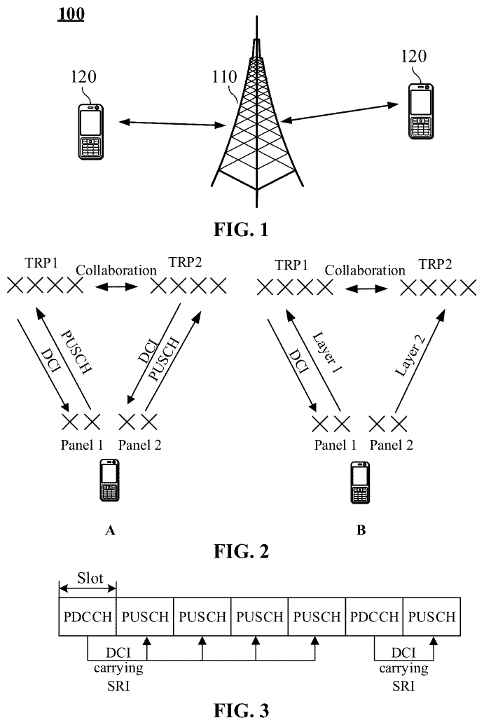

Illustratively, FIG. 1 is a communication system 100 to which embodiments of the disclosure apply. The communication system 100 may include a network device 110. The network device 110 may communicate with a terminal device 120 (also referred to as a communication terminal or a terminal). The network device 110 may provide a specific geographic region with a communication coverage, and may communicate with a terminal device located within the covered region.

Illustratively, FIG. 1 shows one network device and two terminal devices. In some embodiments, the communication system 100 may include multiple network devices, and each network device may cover another number of terminal devices, which is not limited in embodiments of the disclosure.

In some embodiments, the communication system 100 may further include another network entity such as a network controller, a mobile management entity (MME), etc., which is not limited in embodiments of the disclosure.

Understandably, a device capable of communication in a network/system in embodiments of the disclosure may be referred to as a communication device. Taking the communication system 100 as illustrated in FIG. 1 as an example, a communication device may include the network device 110 as well as a terminal device 120 that are capable of communication. The network device 110 and the terminal device 120 may be a specific device as described above, which is not repeated here. A communication device may further include another device in the communication system 100, such as another network entity such as a network controller, an MME, etc., which is not limited in embodiments of the disclosure.

Understandably, terms “system” and network” in the disclosure are often interchangeable in usage. A term “and/or” in the disclosure describes just an association between associated objects, including three possible relationships. For example, by A and/or B, it may mean that there may be three cases, namely, existence of just A, existence of both A and B, or existence of just B. A slash mark “/” in the disclosure generally represents an “or” relationship between two associated objects that come respectively before and after the mark per se.

A term used in detailed description of the disclosure is for explaining embodiments of the disclosure rather than limiting the disclosure. A term “first”, “second”, “third”, “fourth”, etc., in the specification, the claims, and the drawings of the disclosure is just for differentiating different objects, instead of denoting any specific order. In addition, a term such as “including/comprising”, “having”, or any other variant of the term is intended to cover a non-exclusive inclusion.

Understandably, “indication/indicate” mentioned in embodiments of the disclosure may refer to direct indication or indirect indication, and may further mean an association relation. For example, By saying that A indicates B, it may mean that A indicates B directly, such as when B may be acquired through A; it may mean that A indicates B indirectly, such as when A indicates C and B may be acquired through C; or it may mean an association relation between A and B.

In describing an embodiment of the disclosure, a term “corresponding” may mean a direct correspondence or an indirect correspondence between two items, an association between the two, or a relation of indicating and being indicated, configuring and being configured, etc.

In embodiments of the disclosure, “predefining” or “preconfiguring” may be achieved by saving a corresponding code and/or table beforehand in a device (including a terminal device and a network device, for example), or in another mode that may be configured to indicate related information, the specific implementation of which is not limited in embodiments of the disclosure. For example, “predefined” may be as defined in a protocol.

In embodiments of the disclosure, a protocol may refer to a standard protocol in the field of communications, and may include, for example, an LTE protocol, a NR protocol, and a related protocol applying to a future communication system, which is not limited in embodiments of the disclosure.

To facilitate understanding a technical solution according to embodiments of the disclosure, a technical solution of the disclosure is elaborated hereinafter with specific embodiments. The related art may be combined, as optional schemes, with a technical solution according to embodiments of the disclosure as needed. All resulting solutions thus acquired fall in the scope of embodiments of the disclosure. Embodiments of the disclosure include at least some of the following content.

In an NR system, a terminal device may transmit uplink data and uplink control information using an analog beam. The terminal device may perform uplink beam management based on a sounding reference signal (SRS), thereby determining an analog beam used in uplink transmission. Specifically, a network device may configure an SRS resource set for the terminal device, select an SRS resource on which the best receiving quality is achieved based on the SRS transmitted by the terminal device in the SRS resource set, and transmit an SRS resource indicator (SRI) indicating the SRS resource with the best receiving quality to the terminal device. Having received the SRI, the terminal device may determine an analog beam used for the SRS resource indicated by the SRI as an analog beam to be used in transmitting a physical uplink shared channel (PUSCH). A PUSCH scheduled through downlink control information (DCI) may be indicated by the SRI through an SRI indication field in the DCI. A PUSCH scheduled through radio resource control (RRC) may be indicated by the SRI through a scheduling signaling corresponding to the PUSCH.

Multi-TRP based uplink transmission relevant to the disclosure is described to facilitate better understanding of embodiments of the disclosure.

Downlink and uplink non-coherent transmission based on multiple TRPs is introduced in an NR system. An inter-TRP backhaul connection may be ideal or non-ideal. Fast dynamic inter-TRP information exchange may be performed in ideal backhaul. In non-ideal backhaul, just quasi-static inter-TRP information exchange may be performed due to a great delay. In downlink non-coherent transmission, transmission of multiple physical downlink shared channels (PDSCHs) to one terminal may be scheduled by multiple TRPs separately using different control channels, and the transmission by the different TRPs may also be scheduled using one control channel, where data from different TRPs are transmitted using different transport layers. The scheduling using the same control channel can apply just to ideal backhaul.

In uplink non-coherent transmission, physical uplink shared channel (PUSCH) transmission from one terminal may also be scheduled separately by different TRPs. A separate transmission parameter, such as a beam, a pre-coding matrix, a layer number, etc., may be configured for a distinct PUSCH transmission. PUSCHs may be scheduled to be transmitted in the same slot or in different slots. A terminal has to determine a transmission mode according to capacity of the terminal if the terminal is scheduled to transmit two PUSCHs in the same slot. If the terminal is provided with multiple panels, and supports simultaneous PUSCH transmission on the multiple panels, the terminal may transmit the two PUSCHs simultaneously, and analog formation may be performed by aiming PUSCHs transmitted on different panels at respective TRPs, thereby distinguish different PUSCHs spatially, providing uplink spectral efficiency (as illustrated by A in FIG. 2). The terminal may transmit the PUSCHs on just one panel if the terminal has just a single panel or does not support simultaneous transmission on multiple panels. Similar to the downlink case, PUSCHs to be transmitted to different TRPs may be scheduled based on multiple downlink control information (DCI). These DCI may be borne on different control resource sets (CORESETs). Specifically, multiple CORESET groups are configured by the network side. Scheduling may be performed for a TRP using a CORESET in a CORESET group of the TRP per se. That is, different TRPs may be distinguished by the respective CORESET groups. For example, a network device configures one CORESET group index for each CORESET, with different CORESET group indexes corresponding to different TRPs. Similarly, PUSCHs to be transmitted to different TRPs may be scheduled based on a single DCI. In this case, the beams and the demodulation reference signal (DMRS) ports used respectively in transmitting the PUSCHs to the different TRPs are to be indicated in this DCI (as illustrated by B in FIG. 2).

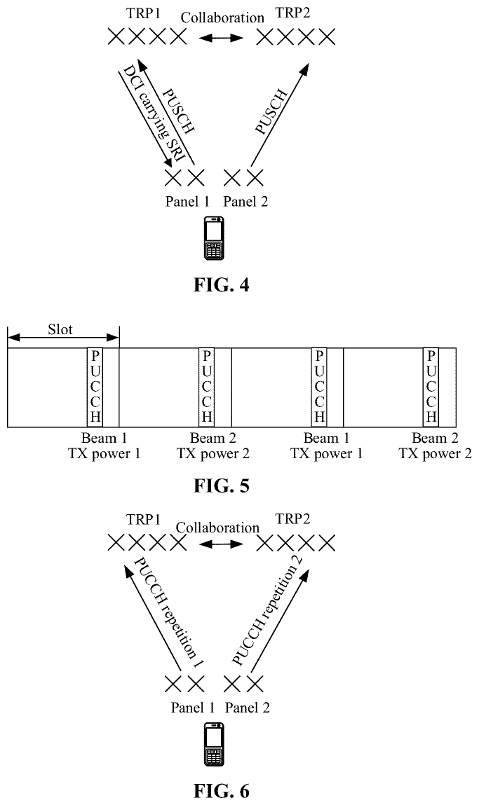

To improve reliability of PUSCH transmission, PUSCH transmission repetition (repetition) is introduced in NR. That is, a PUSCH carrying the same data may be transmitted multiple times through different resources/antennas/redundant versions, etc., thereby acquiring diversity gain, lowering a probability of false detection (such as a block error rate, BLER). Specifically, PUSCH transmission is repeated in multiple slots (as illustrated in FIG. 3) or on multiple panels (as illustrated in FIG. 4). In multi-slot repetition, transmission of multiple PUSCHs in multiple consecutive slots may be scheduled using one DCI, carrying the same data however using different redundant versions. In multi-panel repetition, PUSCHs carrying the same data may be transmitted simultaneously on different panels, and received by the same TRP or by different TRPs.

Like PUSCH, repetition of physical uplink control channel (PUCCH) transmission may also be supported. That is, a PUCCH carrying the same uplink control information may be transmitted multiple times through different resources or antennas, thereby acquiring diversity gain, lowering a probability of false detection (such as BLER). Specifically, PUCCH transmission is repeated in multiple slots (as illustrated in FIG. 5) or on multiple panels (as illustrated in FIG. 6, where the same PUCCH is transmitted simultaneously on multiple panels). In multi-slot repetition, a network device may configure a repetition number N (nrofSlots) for each PUCCH format through RRC signaling. Having received the RRC signaling, a terminal device may transmit the same uplink control information using identical physical resources in N consecutive slots. As PUCCHs in different slots are transmitted to different TRPs, the transmission beams and power control parameters (such as reference signals for pathloss measurement) used in transmission may also be configured separately. For example, N spatial relation information (PUCCH-spatialrelationinfo) or N transmission configuration indicator (TCI) states may be indicated for one PUCCH resource respectively for repeating PUCCH transmission in different slots. PUCCH transmission beams and power control parameters may be acquired from the N spatial relation information (PUCCH-spatialrelationinfo) or the N TCI states. N may denote a number of collaborating TRPs or panels. N=2 for two TRPs, as illustrated in FIG. 6.

Determination of an uplink transmission timing relevant to the disclosure is described to facilitate better understanding of embodiments of the disclosure.

At present, a timing used in transmitting an uplink signal is determined through a method as follows.
1. A downlink timing, i.e., a timing used in receiving a downlink signal, is acquired.
2. A timing advance offset N_{TA,offset} is acquired from an RRC parameter timing advance offset n (n-TimingAdvanceOffset) of a cell. A default offset is used if the RRC parameter is not configured. The same N_{TA,offset} is used if there are multiple uplink carriers in the cell. The same N_{TA,offset} is also used for any cell in one timing advance group (TAG).
3. A timing advance command for one TAG is acquired from a media access control control element (MAC CE). The uplink transmission timing of PUSCH/SRS/PUCCH transmission in any serving cell in the TAG is adjusted based on the timing advance offset N_{TA,offset} and the timing advance command.

It may be seen that an uplink timing is determined according to the downlink timing, the RRC configured timing advance offset and the timing advance command indicated in the MAC CE, and is the same within one TAG. In addition, if overlap occurs in two neighbour slots due to a timing advance (TA) command, the later slot is shortened within a duration of the earlier slot.

An existing technical problem is described to facilitate better understanding of embodiments of the disclosure.

A terminal device receives, using different downlink timings, downlink signals transmitted by two TRPs (if the two TRPs are not completely synchronized). Alternatively, respective propagation delays between the terminal device and the two TRPs may differ a lot, such that respective uplink transmission timings required between the terminal device and the two TRPs may also differ. In this case, there may be performance loss due to asynchronous timings with the TRPs (i.e., a synchronization error exceeding a CP length) if the terminal device transmits uplink signals respectively to the two TRPs using identical uplink transmission timings. There is a pressing need for how a terminal device determines transmission timings of uplink signals sent respectively to different TRPs.

Based on the problem, the disclosure proposes a solution for uplink signal transmission, where a terminal device is allowed to determine different transmission timings for uplink signals to be transmitted to different TRPs, thereby supporting multi-TRP based uplink transmission in a non-synchronization or great transmission delay scene, guaranteeing synchronization of uplink signals transmitted to different TRPs between the TRPs and the terminal device, and avoiding performance loss.

A technical solution of the disclosure is elaborated hereinafter with specific embodiments.

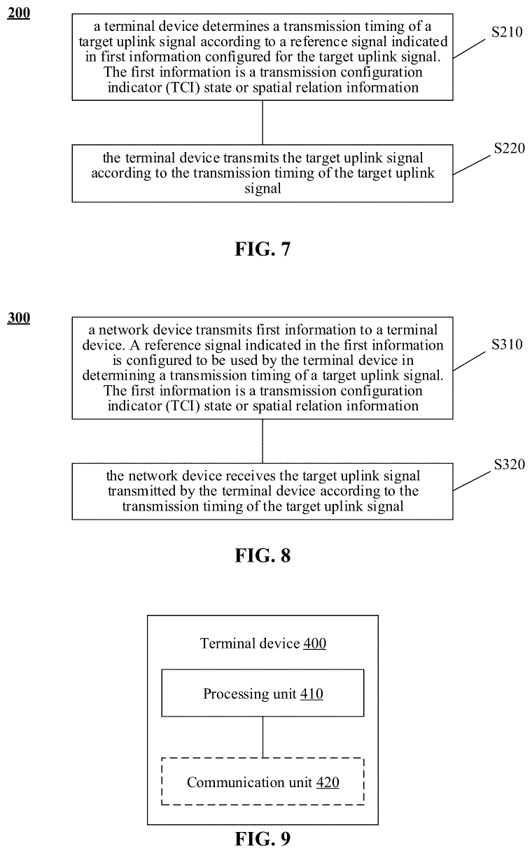

FIG. 7 is a flowchart of a method 200 for wireless communication according to an embodiment of the disclosure. As illustrated in FIG. 7, the method 200 may include at least some of the following content.

At S210, a terminal device determines a transmission timing of a target uplink signal according to a reference signal indicated in first information configured for the target uplink signal. The first information is a transmission configuration indicator (TCI) state or spatial relation information.

At S220, the terminal device transmits the target uplink signal according to the transmission timing of the target uplink signal.

In embodiments of the disclosure, a terminal device determines a transmission timing of a target uplink signal based on a reference signal indicated in a TCI state or spatial relation information configured by a network device for the target uplink signal, and transmits the target uplink signal based on the transmission timing of the target uplink signal. In this case, different uplink signals may have different transmission timings, and one uplink signal may have multiple different transmission timings. That is, different transmission timings may be used for uplink signal(s) to be transmitted to different TRPs, thereby supporting multi-TRP based uplink transmission in a non-synchronization or great transmission delay scene, guaranteeing synchronization of uplink signals transmitted to different TRPs between the TRPs and the terminal device, and avoiding performance loss.

In some embodiments, the first information may also be a parameter other than the TCI state and the spatial relation information, such as a parameter configured by the network device for the target uplink signal for determining the transmission timing, which is not limiting in the disclosure.

In embodiments of the disclosure, a transmission timing may also be referred to as a sending timing, which is not limiting in the disclosure.

In embodiments of the disclosure, the reference signal indicated in the first information configured for the target uplink signal may also be referred to as a reference signal included in the first information configured for the target uplink signal, which is not limiting in the disclosure.

In some embodiments, a quasi-co-located (QCL) type of the TCI state is one of: a transmission timing, an uplink timing, or a synchronization parameter. In another implementation, the QCL type of the TCI state is a QCL typeD, i.e., a spatial transmission/reception parameter (filter). In this case, the terminal device may determine a transmission timing of an uplink signal according to a reference signal configured for determining a transmission beam (spatial domain transmission filter).

In some embodiments, the TCI state may be indicated through a higher layer signaling or a DCI, such as through a media access control (MAC) layer signaling for PUCCH, a DCI for a PUSCH, or an RRC signaling for SRS, etc.

In some embodiments, the spatial relation information is configured for determining the transmission beam (spatial transmission domain filter) of the uplink signal. In this case, the terminal device may determine the transmission timing of the uplink signal according to the reference signal configured for determining the transmission beam (spatial domain transmission filter). Alternatively, the spatial relation information may include an additional reference signal for determining the uplink timing.

In some embodiments, the spatial relation information may be indicated through a higher layer signaling or a DCI, such as through a MAC layer signaling for PUCCH, a DCI for a PUSCH, or an RRC signaling for SRS, etc.

In embodiments of the disclosure, the transmission beam may also be referred to as a spatial domain transmission filter (or spatial domain filter for transmission), a spatial relation, or a spatial setting. A reception beam may also be referred to as a spatial domain reception filter (or spatial domain filter for reception) or a spatial reception parameter (spatial Rx parameter).

In some embodiments, the target uplink signal is a PUSCH or a PUCCH. Of course, the target uplink signal may be some other uplink signal, which is not limiting in the disclosure.

In some embodiments, the reference signal is an uplink reference signal. For example, the uplink reference signal is an SRS. Of course, the uplink reference signal may also be some other uplink reference signal(s), which is not limiting in the disclosure.

In some embodiments, the reference signal is a downlink reference signal. For example, the downlink reference signal is a channel state information reference signal (CSI-RS) or a synchronization signal block (SSB). Of course, the downlink reference signal may also be some other downlink reference signal(s), which is not limiting in the disclosure.

Note that the SSB may also be referred to as a synchronization signal/physical broadcast channel block (SS/PBCH block).

In some embodiments, the reference signal is an uplink reference signal. For example, the uplink reference signal is an SRS. In this case, S210 specifically includes an operation as follows.

The terminal device may take a transmission timing of the uplink reference signal as the transmission timing of the target uplink signal.

For example, the target uplink signal is a PUSCH, and the reference signal included in the TCI state or the spatial relation information is an SRS. Then, the terminal device may take the transmission timing of the SRS as the transmission timing of the PUSCH.

In some embodiments, the reference signal is a downlink reference signal. For example, the downlink reference signal is a CSI-RS or an SSB. In this case, S210 specifically includes an operation as follows.

The terminal device may determine a first downlink timing according to the downlink reference signal. The terminal device may determine the transmission timing of the target uplink signal according to the first downlink timing and a timing advance (TA) determined through higher layer signaling.

In some embodiments, the TA determined through the higher layer signaling includes multiple TAs of a timing advance group (TAG). In this case, the terminal device may determine the transmission timing of the target uplink signal according to the first downlink timing and a target TA of the multiple TAs. In this case, the multiple TAs may correspond respectively to multiple uplink signals, the terminal device may determine respective transmission timings of the multiple uplink signals.

For example, the terminal device computes the transmission timing of the target uplink signal using a formula 1 or a formula 2 as follows.

N_{UL}=N_{DL}+N_{TA} (1)

N_{UL}=N_{DL}−N_{TA} (2)

N_{UL} denotes the transmission timing of the target uplink signal. N_{DL} denotes the first downlink timing. N_{TA} denotes the target TA.

In some embodiments, the TA determined through the higher layer signaling includes multiple TAs of a TAG. In this case, the terminal device may determine multiple transmission timings of the target uplink signal respectively according to the first downlink timing and the multiple TAs. In this case, the terminal device may transmit the target uplink signal respectively according to the N transmission timings. That is, the terminal device may determine multiple transmission timings of one uplink signal.

In some embodiments, the first information is multiple TCI states or multiple pieces of spatial relation information. The multiple TCI states or the multiple pieces of spatial relation information may indicate multiple reference signals. S210 specifically includes an operation as follows. The terminal device may determine multiple transmission timings of the target uplink signal respectively according to the multiple reference signals. S220 specifically includes an operation as follows. The terminal device may transmit the target uplink signal according to the multiple transmission timings of the target uplink signal.

In some embodiments, the terminal device transmits the target uplink signal respectively on different time-domain resources using the multiple transmission timings. Alternatively, the terminal device may transmit the target uplink signal respectively on different panels using the multiple transmission timings.

In some embodiments, the multiple transmission timings are configured for repeating PUSCH or PUCCH transmission on different time-domain resources. That is, different transmission timings may be used for different repetitions. Alternatively, the multiple transmission timings may be configured for PUSCH or PUCCH transmissions on different panels, and the transmissions may be simultaneous or may occupy different time-domain resources.

In some embodiments, the TCI state configured by the network device for the target uplink signal is N TCI states (N>1). Alternatively, the spatial relation information configured by the network device for the target uplink signal may be N spatial relation information (N>1). Then, the terminal device may determine N downlink timings respectively according to N downlink reference signals indicated in the N TCI states or the N spatial relation information. The terminal device may compute the N transmission timings of the target uplink signal respectively based on the N downlink timings and N TAs determined from the higher layer signaling. The terminal device may transmit the target uplink signal respectively according to the N transmission timings.

In some embodiments, one TA may be determined from the higher layer signaling. Alternatively, N TAs determined from the higher layer signaling may have identical values. Specifically, for example, the TCI state configured by the network device for the target uplink signal is N TCI states (N>1). Alternatively, the spatial relation information configured by the network device for the target uplink signal may be N spatial relation information (N>1). Then, the terminal device may determine N downlink timings respectively according to N downlink reference signals indicated in the N TCI states or the N spatial relation information. The terminal device may compute the N transmission timings of the target uplink signal respectively based on the N downlink timings and the one TA determined from the higher layer signaling. The terminal device may transmit the target uplink signal respectively according to the N transmission timings.

Specifically, for example, assume that the target uplink signal is one PUSCH. The network device may configure N TCI states for the PUSCH. Each TCI state may include one downlink reference signal, such as a CSI-RS, for determining a transmission timing. The terminal device may determine N downlink timings according to the downlink reference signals included in the N TCI states. In addition, the terminal device may acquire N TAs from the MAC CE and/or the RRC signaling configured by the network device. The terminal device may determine N uplink transmission timings for transmitting the PUSCH according to respective combinations of the N downlink timings and the N TAs.

In some embodiments, the reference signals included in the N TCI states are of the same type (all CSI-RSs, for example), or of different types (where one TCI state includes a CSI-RS, and another includes an SSB, for example).

In some embodiments, assume that the target uplink signal is one PUSCH. The network device may configure multiple TCI states for the PUSCH. Each TCI state may include one uplink reference signal, such as an SRS, for determining a transmission timing. The terminal device may determine multiple transmission timings according to the uplink reference signals included in the multiple TCI states. The terminal device may transmit the PUSCH respectively using the multiple transmission timings. The multiple transmission timings are configured for repeating PUSCH transmission on different time-domain resources. That is, different transmission timings may be used for different repetitions. Alternatively, the multiple transmission timings may be configured for PUSCH transmissions on different panels, and the transmissions may be simultaneous or may occupy different time-domain resources. In addition, the reference signals included in the multiple TCI states are of the same type (all SRSs, for example), or of different types (where one TCI state includes an SRS, and another includes a CSI-RS, for example).

In some embodiments, the multiple TAs are in one-to-one correspondence with different control resource set (CORESET) group indexes. The target TA may be a TA corresponding to a CORESET group index associated with the target uplink signal.

In some embodiments, a TA corresponds to a TA offset. Specifically, for example, assume that a first TA offset and a second TA offset are associated with CORESET group indexes 0 and 1, respectively; that a first PUSCH is associated with the CORESET group index 0 (that is, a PDCCH used to schedule the first PUSCH is located in a CORESET provided with a group index 0); and that a second PUSCH is associated with the CORESET group index 1 (that is, a PDCCH used to schedule the second PUSCH is located in a CORESET provided with a group index 1). Then, the terminal device may determine the transmission timing of the first PUSCH according to the first TA offset, and determine the transmission timing of the second PUSCH according to the second TA offset.

In some embodiments, the multiple TAs are in one-to-one correspondence with different cell identities (IDs). The target TA may be a TA corresponding to a cell ID associated with the target uplink signal.

In some embodiments, a TA corresponds to a TA command. Specifically, for example, assume that a first TA command and a second TA command are associated with a physical cell identifier (PCI) of a serving cell (primary cell ID) and a PCI of a neighbour cell (secondary cell ID), respectively; that a first PUSCH is associated with the PCI of the serving cell (that is, a pathloss reference signal or a transmission beam of the first PUSCH comes from an SSB carrying the PCI); and that a second PUSCH is associated with the PCI of the neighbour cell (that is, a pathloss reference signal or a transmission beam of the second PUSCH comes from an SSB carrying the PCI). Then, the terminal device may determine the transmission timing of the first PUSCH according to the first TA command, and determine the transmission timing of the second PUSCH according to the second TA command.

In some embodiments, the target uplink signal includes a first uplink signal and a second uplink signal. A first reference signal may be indicated in the first information configured for the first uplink signal. A second reference signal may be indicated in the first information configured for the second uplink signal. S210 specifically includes an operation as follows. The terminal device may determine a first transmission timing of the first uplink signal according to the first reference signal. The terminal device may determine a second transmission timing of the second uplink signal according to the second reference signal. S220 specifically includes an operation as follows. The terminal device may transmit the first uplink signal and the second uplink signal respectively according to the first transmission timing and the second transmission timing. In this case, the terminal device may determine respective transmission timings of multiple uplink signals.

In some embodiments, the first transmission timing is different from the second transmission timing.

For example, a time-domain resource occupied by the first uplink signal does not overlap a time-domain resource occupied by the second uplink signal.

As another example, the time-domain resource occupied by the first uplink signal overlaps the time-domain resource occupied by the second uplink signal due to different transmission timings.

In some embodiments, the first uplink signal and the second uplink signal occupy different time-domain resources. That is, the terminal device may transmit the first uplink signal and the second uplink signal respectively on different time-domain resources using the first transmission timing and the second transmission timing. Additionally or alternatively, the first uplink signal and the second uplink signal may be transmitted through different panels. That is, the terminal device may transmit the first uplink signal and the second uplink signal respectively on different panels using the first transmission timing and the second transmission timing.

In some embodiments, in a case where the first uplink signal and the second uplink signal occupy different time-domain resources, and where the time-domain resource occupied by the first uplink signal overlaps the time-domain resource occupied by the second uplink signal due to different transmission timings, the terminal device does not transmit, in an overlapping region, an uplink signal of the first uplink signal and the second uplink signal that comes later in time domain.

In some embodiments, the uplink signal is a PUSCH (or a PUCCH, or some other uplink signal). A reference signal indicated in a TCI state or spatial relation information configured for the PUSCH may be a CSI-RS. Specifically, for example, a TCI state (or spatial relation information) configured by the network device for a first PUSCH includes a first CSI-RS. The first CSI-RS may be a CSI-RS transmitted by a first TRP. A TCI state (or spatial relation information) configured by the network device for a second PUSCH may include a second CSI-RS. The second CSI-RS may be a CSI-RS transmitted by a second TRP. Separate downlink timings (determined respectively by the two TRPs) may be used for the first CSI-RS and the second CSI-RS. In this case, the terminal device may further acquire two TAs, denoted respectively by a first TA and a second TA, from the higher layer signaling. The terminal device may determine the first downlink timing according to the first CSI-RS, and then determine the transmission timing of the first PUSCH according to the first downlink timing and the first TA. The terminal device may determine the second downlink timing according to the second CSI-RS, and then determine the uplink transmission timing of the second PUSCH according to the second downlink timing and the second TA. The terminal device may thereby transmit the first PUSCH and the second PUSCH using separate uplink transmission timings.

In some embodiments, the uplink signal is a PUSCH (or a PUCCH, or some other uplink signal). A reference signal indicated in a TCI state or spatial relation information configured for the PUSCH may be an SRS. A TCI state (or spatial relation information) configured by the network device for a first PUSCH may include a first SRS. The first SRS may be an SRS transmitted to a first TRP. A TCI state (or spatial relation information) configured by the network device for a second PUSCH may include a second SRS. The second SRS may be an SRS transmitted to a second TRP. Different transmission timings may be used for the first SRS and the second SRS. In this case, the terminal device may take the transmission timing of the first SRS as the transmission timing of the first PUSCH, and take the transmission timing of the second SRS as the transmission timing of the second PUSCH, thereby transmitting the first PUSCH and the second PUSCH using separate uplink transmission timings.

In some embodiments, the terminal device transmits the first PUSCH and the second PUSCH respectively on different time-domain resources using separate uplink transmission timings. That is, the terminal device may use just one transmission timing at one time point, but may use multiple different transmission timings at different time points, depending on a reference signal. If two uplink signals are to be transmitted on different time-domain resources, and time-domain resource overlap occurs due to different transmission timings, the terminal device may not transmit, within an overlapping period, an uplink signal that comes later in time. For example, the first PUSCH and the second PUSCH are to be transmitted in neighbour slots. However, advance of the timing of the second PUSCH leads to time-domain overlap with the first PUSCH. In this case, the terminal device may transmit the first PUSCH as usual, however does not transmit, in the overlapping part, the second PUSCH.

In some embodiments, the terminal device transmits the first PUSCH and the second PUSCH respectively on different panels using separate uplink transmission timings. In this case, the transmission timings on different panels may differ.

In some embodiments, the terminal device determines multiple TAs of one TAG in one mode of modes 1 to 3 as follows.

In mode 1, the network device may configure multiple TA offsets of the TAG through RRC. One TA command of the TAG may be transmitted at a time using a MAC CE. The terminal device may determine the multiple TAs of the TAG according to each TA offset of the multiple TA offsets and the TA command.

In mode 2, the network device may configure multiple TA offsets of the TAG through RRC. Multiple TA commands of the TAG may be transmitted at a time using a MAC CE. The multiple TA offsets are in one-to-one correspondence with the multiple TA commands. The terminal device may determine the multiple TAs of the TAG according to each TA offset and each TA command.

In mode 3, the network device may configure one TA offset (i.e., an initial TA offset) of the TAG through RRC. Multiple TA commands of the TAG may be transmitted at a time using a MAC CE. The terminal device may determine the multiple TAs of the TAG according to the initial TA offset and each TA command.

In some embodiments, the target uplink signal may also be a PUCCH. For example, multiple pieces of spatial relation information (PUCCH-spatialrelatininfo) are configured for the PUCCH, thereby acquiring multiple transmission timings. The target uplink signal may also be some other uplink signal such as an SRS.

In some embodiments, reference signals corresponding to different uplink signals may be of different types, and are not necessarily all uplink reference signals or all downlink reference signals. For example, reference signals for determining transmission timings corresponding to three different uplink signals are a CSI-RS, an SSB, and an SRS, respectively.

In some embodiments, the first information further includes timing state indication information. The terminal device may determine a timing state associated with the transmission timing of the target uplink signal according to the timing state indication information.

Specifically, the terminal device determines a downlink timing according to the downlink reference signal indicated in the TCI state or the spatial relation information configured for the target uplink signal, and computes the transmission timing of the target uplink signal based on the downlink timing and a TA corresponding to the timing state indicated in the TCI state or the spatial relation information.

In some embodiments, a same transmission timing is used for uplink signals configured with a same timing state.

Specifically, for example, the terminal device takes a transmission timing of an uplink reference signal as the transmission timing of any uplink signal adopting a first timing state in a case where reference signal indicated in the TCI state or the spatial relation information is the uplink reference signal. The first timing state may be a timing state indicated in the TCI state or the spatial relation information. That is, the terminal device may assume that identical transmission timings are used for uplink signals provided with identical timing states. For example, assume that the network device configures a timing state index 0 for another uplink signal. The terminal device may transmit said another uplink signal using a transmission timing 1 corresponding to the timing state index 0. If the network device configures a timing state index 1 for said another uplink signal, the terminal may transmit said another uplink signal using a transmission timing 2 corresponding to the timing state index 1. In this case, instead of configuring a reference signal for the transmission timing for said another uplink signal, the network device may configure just a timing state index, to allow the terminal device to determine a transmission timing corresponding to the timing state index.

In some embodiments, in a case where reference signal indicated in the first information is an uplink reference signal, the terminal device takes a transmission timing of the uplink reference signal as a transmission timing of an uplink signal adopting a first timing state. The first timing state may be a timing state indicated by the timing state indication information in the first information. The uplink signal may include the target uplink signal.

In some embodiments, in a case where reference signal indicated in the first information is a downlink reference signal, the terminal device determines a first downlink timing according to the downlink reference signal. The terminal device may determine the transmission timing of the target uplink signal according to the first downlink timing and a timing advance (TA) corresponding to a second timing state. The second timing state may be a timing state indicated by the timing state indication information in the first information.

In some embodiments, the terminal device determines at least one TA corresponding respectively to at least one timing state according to higher layer signaling. The at least one timing state may include the second timing state.

Specifically, for example, the terminal device determines a TA corresponding respectively to each timing state of the at least one timing state from the higher layer signaling. For example, at least one of a TA offset or a TA command corresponding to each timing state is indicated through the higher layer signaling if the network device configures two timing states, thereby determining the TA corresponding to the each timing state through at least one of the TA offset or the TA command. For example, two TA offsets are configured through the higher layer signaling. Alternatively, two TA commands are indicated through the MAC CE. The terminal device may thereby acquire two TAs.

In some embodiments, one TCI state or one piece of spatial relation information includes indication information indicating a downlink reference signal, and a timing state index.

The downlink reference signal may be a downlink reference signal for determining a transmission timing.

Specifically, for example, the terminal device determines a downlink timing 1 for a PUSCH according to a downlink reference signal in the TCI state. The downlink timing 1 may be associated with a timing state index 0. The terminal device may determine a downlink timing 2 for a PUCCH according to a downlink reference signal in the spatial relation information. The downlink timing 2 may be associated with a timing state index 1. In addition, the terminal device may learn through the higher layer signaling that the timing state 0 and the timing state 1 correspond to a TA 1 and a TA 2, respectively. The terminal device may determine a transmission timing corresponding to the timing state 0 according to the downlink timing 1 and the TA 1, and take the transmission timing corresponding to the timing state 0 as the transmission timing of the PUSCH. The terminal device may determine a transmission timing corresponding to the timing state 1 according to the downlink timing 2 and the TA 2, and take the transmission timing corresponding to the timing state 1 as the transmission timing of the PUCCH.

In some embodiments, one TCI state or one piece of spatial relation information includes indication information indicating an uplink reference signal, and a timing state index.

The uplink reference signal may be an uplink reference signal for determining a transmission timing.

Specifically, for example, the terminal device determines a transmission timing 1 for a PUSCH according to an uplink reference signal in the TCI state. The transmission timing 1 may be associated with a timing state index 0. The terminal device may determine a transmission timing 2 for a PUCCH according to an uplink reference signal in the spatial relation information. The transmission timing 2 may be associated with a timing state index 1. Then, the terminal device may have to maintain transmission timings corresponding respectively to the two timing states. The terminal device may take a transmission timing corresponding to the timing state 0 as the transmission timing of the PUSCH. The terminal device may take a transmission timing corresponding to the timing state 1 as the transmission timing of the PUCCH.

In some embodiments, two TCI states or two pieces of spatial relation information are configured for one uplink signal (such as one target uplink signal). Each TCI state or each piece of spatial relation information may include a timing state index. Timing state indexes in the two TCI states or the two pieces of spatial relation information may differ. That is, one uplink signal (such as one target uplink signal) may be associated with multiple timing states. The terminal device may determine transmission timings corresponding respectively to the two timing states for transmitting the target uplink signal at different time or on different panels.

In some embodiments, the terminal device assumes that the transmission timing of the target uplink signal is associated with a timing state 0 in a case where first information does not include timing state indication information. In this case, the terminal device determines the transmission timing of the target uplink signal according to a downlink timing of the serving cell and a first TA configured through the higher layer signaling. Alternatively, the terminal device may determine the transmission timing of the target uplink signal to be an uplink timing of the serving cell. That is, no additional reference signal is needed for determining the transmission timing.

In some embodiments, the TA is obtained based on at least one of a TA offset configured through radio resource control (RRC) signaling, or a TA command indicated through media access control (MAC) layer signaling. Alternatively, the TA may include at least one of the TA offset configured through the RRC signaling, or the TA command indicated through the MAC layer signaling. For example, a TA may be computed according to an RRC configured TA offset and a TA command indicated through a modulation and coding scheme (MCS) layer.

Therefore, in embodiments of the disclosure, a terminal device determines a transmission timing of a target uplink signal based on a reference signal indicated in a TCI state or spatial relation information configured by a network device for the target uplink signal, and transmits the target uplink signal based on the transmission timing of the target uplink signal. In this case, different uplink signals may have different transmission timings, and one uplink signal may have multiple different transmission timings. That is, different transmission timings may be used for uplink signal(s) to be transmitted to different TRPs, thereby supporting multi-TRP based uplink transmission in a non-synchronization or great transmission delay scene, guaranteeing synchronization of uplink signals transmitted to different TRPs between the TRPs and the terminal device, and avoiding performance loss.

Embodiments of the disclosure may also support determining multiple different transmission timings for one uplink signal, thereby supporting multi-TRP based uplink repetition, guaranteeing a gain of uplink repetition in a non-synchronization scene.

Terminal embodiments of the disclosure are elaborated with reference to FIG. 7. Network side embodiments of the disclosure are elaborated hereinafter with reference to FIG. 8. Understandably, the network side embodiments correspond respectively to the terminal embodiments. Refer to the terminal embodiments for similar description in the network side embodiments.

FIG. 8 is a flowchart of a method 300 for wireless communication according to an embodiment of the disclosure. As illustrated in FIG. 8, the method 300 may include at least some of the following content.

At S310, a network device transmits first information to a terminal device. A reference signal indicated in the first information is configured to be used by the terminal device in determining a transmission timing of a target uplink signal. The first information is a transmission configuration indicator (TCI) state or spatial relation information.

At S320, the network device receives the target uplink signal transmitted by the terminal device according to the transmission timing of the target uplink signal.

In embodiments of the disclosure, a terminal device determines a transmission timing of a target uplink signal based on a reference signal indicated in a TCI state or spatial relation information configured by a network device for the target uplink signal, and transmits the target uplink signal based on the transmission timing of the target uplink signal. In this case, different uplink signals may have different transmission timings, and one uplink signal may have multiple different transmission timings. That is, different transmission timings may be used for uplink signal(s) to be transmitted to different TRPs, thereby supporting multi-TRP based uplink transmission in a non-synchronization or great transmission delay scene, guaranteeing synchronization of uplink signals transmitted to different TRPs between the TRPs and the terminal device, and avoiding performance loss.

In some embodiments, the network device receives, according to a reception timing of the target uplink signal, the target uplink signal transmitted by the terminal device according to the transmission timing of the target uplink signal.

In some embodiments, the first information may also be a parameter other than the TCI state and the spatial relation information, such as a parameter configured by the network device for the target uplink signal for determining the transmission timing, which is not limiting in the disclosure.

In embodiments of the disclosure, a transmission timing may also be referred to as a sending timing, which is not limiting in the disclosure.

In embodiments of the disclosure, “reference signal indicated in the first information is configured to be used by the terminal device in determining a transmission timing of a target uplink signal” may also be referred to as “reference signal included in the first information is configured to be used by the terminal device in determining a transmission timing of a target uplink signal”, which is not limiting in the disclosure.

In some embodiments, a quasi-co-located (QCL) type of the TCI state is one of: a transmission timing, an uplink timing, or a synchronization parameter. In another implementation, the QCL type of the TCI state is a QCL typeD, i.e., a spatial transmission/reception parameter (filter). In this case, the terminal device may determine a transmission timing of an uplink signal according to a reference signal configured for determining a transmission beam (spatial domain transmission filter).

In some embodiments, the TCI state may be indicated through a higher layer signaling or a DCI, such as through a media access control (MAC) layer signaling for PUCCH, a DCI for a PUSCH, or an RRC signaling for SRS, etc.

In some embodiments, the spatial relation information is configured for determining the transmission beam (spatial domain transmission filter) of the uplink signal. In this case, the terminal device may determine the transmission timing of the uplink signal according to the reference signal configured for determining the transmission beam (spatial domain transmission filter). Alternatively, the spatial relation information may include an additional reference signal for determining the uplink timing.

In some embodiments, the spatial relation information may be indicated through a higher layer signaling or a DCI, such as through a MAC layer signaling for PUCCH, a DCI for a PUSCH, or an RRC signaling for SRS, etc.

In embodiments of the disclosure, the transmission beam may also be referred to as a spatial domain transmission filter (or spatial domain filter for transmission), a spatial relation, or a spatial setting. A reception beam may also be referred to as a spatial domain reception filter (or spatial domain filter for reception) or a spatial reception parameter (spatial Rx parameter).

In some embodiments, the target uplink signal is a PUSCH or a PUCCH. Of course, the target uplink signal may be some other uplink signal, which is not limiting in the disclosure.

In some embodiments, the network device takes a reception timing of an uplink reference signal as a reception timing of the target uplink signal in a case where reference signal is the uplink reference signal. For example, the uplink reference signal is an SRS. Of course, the uplink reference signal may also be some other uplink reference signal(s), which is not limiting in the disclosure.

In some embodiments, the network device determines a reception timing of the target uplink signal according to a transmission timing of a downlink reference signal and a timing advance (TA) determined through higher layer signaling in a case where reference signal is the downlink reference signal. For example, the downlink reference signal is a channel state information reference signal (CSI-RS) or a synchronization signal block (SSB). Of course, the downlink reference signal may also be some other downlink reference signal(s), which is not limiting in the disclosure.

In some embodiments, the TA determined through the higher layer signaling includes multiple TAs of a timing advance group (TAG). The network device may determine the reception timing of the target uplink signal according to the transmission timing of the downlink reference signal and a target TA of the multiple TAs.

In some embodiments, the multiple TAs are in one-to-one correspondence with different control resource set (CORESET) group indexes. The target TA may be a TA corresponding to a CORESET group index associated with the target uplink signal.

In some embodiments, a TA corresponds to a TA offset. Specifically, for example, assume that a first TA offset and a second TA offset are associated with CORESET group indexes 0 and 1, respectively; that a first PUSCH is associated with the CORESET group index 0 (that is, a PDCCH used to schedule the first PUSCH is located in a CORESET provided with a group index 0); and that a second PUSCH is associated with the CORESET group index 1 (that is, a PDCCH used to schedule the second PUSCH is located in a CORESET provided with a group index 1). Then, the terminal device may determine the transmission timing of the first PUSCH according to the first TA offset, and determine the transmission timing of the second PUSCH according to the second TA offset.

In some embodiments, the multiple TAs are in one-to-one correspondence with different cell identities (IDs). The target TA may be a TA corresponding to a cell ID associated with the target uplink signal.

In some embodiments, a TA corresponds to a TA command. Specifically, for example, assume that a first TA command and a second TA command are associated with a physical cell identifier (PCI) of a serving cell (primary cell ID) and a PCI of a neighbour cell (secondary cell ID), respectively; that a first PUSCH is associated with the PCI of the serving cell (that is, a pathloss reference signal or a transmission beam of the first PUSCH comes from an SSB carrying the PCI); and that a second PUSCH is associated with the PCI of the neighbour cell (that is, a pathloss reference signal or a transmission beam of the second PUSCH comes from an SSB carrying the PCI). Then, the terminal device may determine the transmission timing of the first PUSCH according to the first TA command, and determine the transmission timing of the second PUSCH according to the second TA command.

In some embodiments, the multiple TAs are in one-to-one correspondence with different TRPs. The target TA may be a TA corresponding to a receiving TRP of the target uplink signal.

In some embodiments, the TA determined through the higher layer signaling includes multiple TAs of a timing advance group (TAG). The network device may determine multiple reception timings of the target uplink signal respectively according to the transmission timing of the downlink reference signal and the multiple TAs.

In some embodiments, the target uplink signal includes a first uplink signal and a second uplink signal. A first reference signal may be indicated in the first information configured for the first uplink signal. A second reference signal may be indicated in the first information configured for the second uplink signal. The network device may determine a first reception timing of the first uplink signal according to the first reference signal, and determine a second reception timing of the second uplink signal according to the second reference signal. In this case, S310 specifically includes an operation as follows. The network device may receive, respectively according to the first reception timing and the second reception timing, the first uplink signal and the second uplink signal transmitted by the terminal device.

In some embodiments, the first reception timing is different from the second reception timing.

In some embodiments, the first uplink signal and the second uplink signal occupy different time-domain resources, and/or the first uplink signal and the second uplink signal are received through different TRPs.

In some embodiments, in a case where the first uplink signal and the second uplink signal occupy different time-domain resources, and where a time-domain resource occupied by the first uplink signal overlaps a time-domain resource occupied by the second uplink signal due to different transmission timings, the network device does not receive, in an overlapping region, an uplink signal of the first uplink signal and the second uplink signal that comes later in time domain.

In some embodiments, the first information is multiple TCI states or multiple pieces of spatial relation information. The multiple TCI states or the multiple pieces of spatial relation information may indicate multiple reference signals. The network device may determine multiple reception timings of the target uplink signal respectively according to the multiple reference signals. In this case, S310 specifically includes an operation as follows. The network device may receive the target uplink signal according to the multiple reception timings of the target uplink signal.

In some embodiments, the network device receives the target uplink signal respectively on different time-domain resources using the multiple reception timings of the target uplink signal. Alternatively, the network device may receive the target uplink signal respectively through different TRPs using the multiple reception timings of the target uplink signal.

In some embodiments, the network device may configure multiple TA offsets of the TAG through RRC. One TA command of the TAG may be transmitted at a time using a MAC CE. The terminal device may determine the multiple TAs of the TAG according to each TA offset of the multiple TA offsets and the TA command.

In some embodiments, the network device may configure multiple TA offsets of the TAG through RRC. Multiple TA commands of the TAG may be transmitted at a time using a MAC CE. The multiple TA offsets are in one-to-one correspondence with the multiple TA commands. The terminal device may determine the multiple TAs of the TAG according to each TA offset and each TA command.

In some embodiments, the network device may configure one TA offset (i.e., an initial TA offset) of the TAG through RRC. Multiple TA commands of the TAG may be transmitted at a time using a MAC CE. The terminal device may determine the multiple TAs of the TAG according to the initial TA offset and each TA command.

In some embodiments, the target uplink signal may also be a PUCCH. For example, multiple pieces of spatial relation information (PUCCH-spatialrelatininfo) are configured for the PUCCH, thereby acquiring multiple transmission timings. The target uplink signal may also be some other uplink signal such as an SRS.

In some embodiments, reference signals corresponding to different uplink signals may be of different types, and are not necessarily all uplink reference signals or all downlink reference signals. For example, reference signals for determining transmission timings corresponding to three different uplink signals are a CSI-RS, an SSB, and an SRS, respectively.

In some embodiments, the first information further includes timing state indication information. The timing state indication information is configured to be used by the terminal device in determining a timing state associated with the transmission timing of the target uplink signal.

In some embodiments, a same transmission timing is used for uplink signals configured with a same timing state.

Specifically, the network device configures a timing state index 0. The terminal device may transmit the uplink signal using a transmission timing 1 corresponding to the timing state index 0. If the network device configures a timing state index 1, the terminal may transmit the uplink signal using a transmission timing 2 corresponding to the timing state index 1. In this case, instead of configuring a reference signal for the transmission timing for the uplink signal, the network device may configure just a timing state index, to allow the terminal device to determine a transmission timing corresponding to the timing state index.

In some embodiments, in a case where reference signal indicated in the first information is an uplink reference signal, the network device takes a reception timing of the uplink reference signal as a reception timing of an uplink signal adopting a first timing state. The first timing state may be a timing state indicated by the timing state indication information in the first information. The uplink signal may include the target uplink signal.

In some embodiments, in a case where reference signal indicated in the first information is a downlink reference signal, the network device determines a reception timing of the target uplink signal according to a transmission timing of the downlink reference signal and a timing advance (TA) corresponding to a second timing state. The second timing state may be a timing state indicated by the timing state indication information in the first information.

In some embodiments, the network device indicates, to the terminal device, at least one TA corresponding respectively to at least one timing state through higher layer signaling. The at least one timing state may include the second timing state.

Specifically, for example, the terminal device determines a TA corresponding respectively to each timing state of the at least one timing state from the higher layer signaling. For example, at least one of a TA offset or a TA command corresponding to each timing state is indicated through the higher layer signaling if the network device configures two timing states, thereby determining the TA corresponding to the each timing state through at least one of the TA offset or the TA command. For example, two TA offsets are configured through the higher layer signaling. Alternatively, two TA commands are indicated through the MAC CE. The terminal device may thereby acquire two TAs.

In some embodiments, one TCI state or one piece of spatial relation information includes indication information indicating a downlink reference signal, and a timing state index.

The downlink reference signal may be a downlink reference signal for determining a transmission timing.

Specifically, for example, the terminal device determines a downlink timing 1 for a PUSCH according to a downlink reference signal in the TCI state. The downlink timing 1 may be associated with a timing state index 0. The terminal device may determine a downlink timing 2 for a PUCCH according to a downlink reference signal in the spatial relation information. The downlink timing 2 may be associated with a timing state index 1. In addition, the terminal device may learn through the higher layer signaling that the timing state 0 and the timing state 1 correspond to a TA 1 and a TA 2, respectively. The terminal device may determine a transmission timing corresponding to the timing state 0 according to the downlink timing 1 and the TA 1, and take the transmission timing corresponding to the timing state 0 as the transmission timing of the PUSCH. The terminal device may determine a transmission timing corresponding to the timing state 1 according to the downlink timing 2 and the TA 2, and take the transmission timing corresponding to the timing state 1 as the transmission timing of the PUCCH.

In some embodiments, one TCI state or one piece of spatial relation information includes indication information indicating an uplink reference signal, and a timing state index.

The uplink reference signal may be an uplink reference signal for determining a transmission timing.

Specifically, for example, the terminal device determines a transmission timing 1 for a PUSCH according to an uplink reference signal in the TCI state. The transmission timing 1 may be associated with a timing state index 0. The terminal device may determine a transmission timing 2 for a PUCCH according to an uplink reference signal in the spatial relation information. The transmission timing 2 may be associated with a timing state index 1. Then, the terminal device may have to maintain transmission timings corresponding respectively to the two timing states. The terminal device may take a transmission timing corresponding to the timing state 0 as the transmission timing of the PUSCH. The terminal device may take a transmission timing corresponding to the timing state 1 as the transmission timing of the PUCCH.

In some embodiments, two TCI states or two pieces of spatial relation information are configured for one uplink signal (such as one target uplink signal). Each TCI state or each piece of spatial relation information may include a timing state index. Timing state indexes in the two TCI states or the two pieces of spatial relation information may differ. That is, one uplink signal (such as one target uplink signal) may be associated with multiple timing states. The terminal device may determine transmission timings corresponding respectively to the two timing states for transmitting the target uplink signal at different time or on different panels.

In some embodiments, the terminal device assumes that the transmission timing of the target uplink signal is associated with a timing state 0 in a case where first information does not include timing state indication information. In this case, the terminal device determines the transmission timing of the target uplink signal according to a downlink timing of the serving cell and a first TA configured through the higher layer signaling. Alternatively, the terminal device may determine the transmission timing of the target uplink signal to be an uplink timing of the serving cell. That is, no additional reference signal is needed for determining the transmission timing.

In some embodiments, the TA is obtained based on at least one of a TA offset configured through radio resource control (RRC) signaling, or a TA command indicated through media access control (MAC) layer signaling. Alternatively, the TA may include at least one of the TA offset configured through the RRC signaling, or the TA command indicated through the MAC layer signaling. For example, a TA may be computed according to an RRC configured TA offset and a TA command indicated through a modulation and coding scheme (MCS) layer.

Therefore, in embodiments of the disclosure, a terminal device determines a transmission timing of a target uplink signal based on a reference signal indicated in a TCI state or spatial relation information configured by a network device for the target uplink signal, and transmits the target uplink signal based on the transmission timing of the target uplink signal. In this case, different uplink signals may have different transmission timings, and one uplink signal may have multiple different transmission timings. That is, different transmission timings may be used for uplink signal(s) to be transmitted to different TRPs, thereby supporting multi-TRP based uplink transmission in a non-synchronization or great transmission delay scene, guaranteeing synchronization of uplink signals transmitted to different TRPs between the TRPs and the terminal device, and avoiding performance loss.

Embodiments of the disclosure may also support determining multiple different transmission timings for one uplink signal, thereby supporting multi-TRP based uplink repetition, guaranteeing a gain of uplink repetition in a non-synchronization scene.

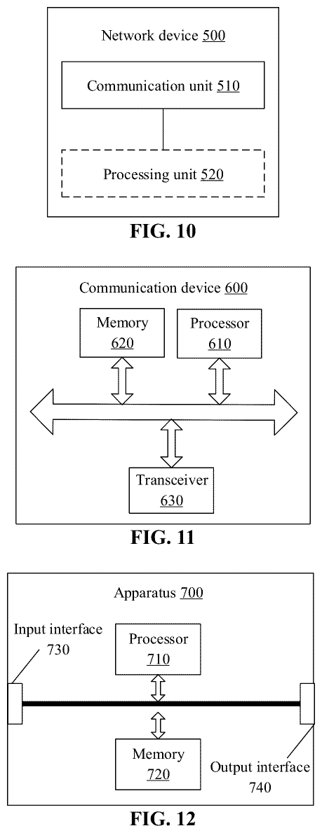

Method embodiments of the disclosure are elaborated with reference to FIG. 7 to FIG. 8. Apparatus embodiments of the disclosure are elaborated hereinafter with reference to FIG. 9 to FIG. 10. Understandably, the apparatus embodiments correspond respectively to the method embodiments. Refer to the method embodiments for similar description in the apparatus embodiments.

FIG. 9 is a block diagram of a terminal device 400 according to an embodiment of the disclosure. As illustrated in FIG. 9, the terminal device 400 may include a processing unit and a communication unit.

The processing unit 410 is configured to determine a transmission timing of a target uplink signal according to a reference signal indicated in first information configured for the target uplink signal. The first information is a transmission configuration indicator (TCI) state or spatial relation information.

The communication unit 420 is configured to transmit the target uplink signal according to the transmission timing of the target uplink signal.

In some embodiments, the reference signal is an uplink reference signal.

The processing unit 410 is specifically configured to take a transmission timing of the uplink reference signal as the transmission timing of the target uplink signal.

In some embodiments, the reference signal is a downlink reference signal.

The processing unit 410 is specifically configured to:
determine a first downlink timing according to the downlink reference signal; and
determine the transmission timing of the target uplink signal according to the first downlink timing and a timing advance (TA) determined through higher layer signaling.

In some embodiments, the TA determined through the higher layer signaling includes multiple TAs of a timing advance group (TAG).

The processing unit 410 is specifically configured to determine the transmission timing of the target uplink signal according to the first downlink timing and a target TA of the multiple TAs.

In some embodiments, the multiple TAs are in one-to-one correspondence with different control resource set (CORESET) group indexes. The target TA is a TA corresponding to a CORESET group index associated with the target uplink signal.

Alternatively, the multiple TAs are in one-to-one correspondence with different cell identities (IDs). The target TA is a TA corresponding to a cell ID associated with the target uplink signal.

In some embodiments, the TA determined through the higher layer signaling includes multiple TAs of a timing advance group (TAG).

The processing unit 410 is specifically configured to respectively determine multiple transmission timings of the target uplink signal according to the first downlink timing and the multiple TAs.

In some embodiments, the target uplink signal includes a first uplink signal and a second uplink signal. A first reference signal may be indicated in the first information configured for the first uplink signal. A second reference signal may be indicated in the first information configured for the second uplink signal.

The processing unit 410 is specifically configured to determine a first transmission timing of the first uplink signal according to the first reference signal, and determine a second transmission timing of the second uplink signal according to the second reference signal.

The communication unit 420 is specifically configured to transmit the first uplink signal and the second uplink signal respectively according to the first transmission timing and the second transmission timing.

In some embodiments, the first transmission timing is different from the second transmission timing.

In some embodiments, the first uplink signal and the second uplink signal occupy different time-domain resources, and/or the first uplink signal and the second uplink signal are transmitted through different panels.

In some embodiments, in a case where the first uplink signal and the second uplink signal occupy different time-domain resources, and where a time-domain resource occupied by the first uplink signal overlaps a time-domain resource occupied by the second uplink signal due to different transmission timings, the terminal device does not send, in an overlapping region, an uplink signal of the first uplink signal and the second uplink signal that comes later in time domain.

In some embodiments, the first information is multiple TCI states or multiple pieces of spatial relation information. The multiple TCI states or the multiple pieces of spatial relation information may indicate multiple reference signals.

The processing unit 410 is specifically configured to determine multiple transmission timings of the target uplink signal respectively according to the multiple reference signals.

The communication unit 420 is specifically configured to transmit the target uplink signal according to the multiple transmission timings of the target uplink signal.

In some embodiments, the communication unit 420 is specifically configured to:
transmit the target uplink signal respectively on different time-domain resources using the multiple transmission timings; or
transmit the target uplink signal respectively on different panels using the multiple transmission timings.

In some embodiments, the first information further includes timing state indication information.

The processing unit 410 is further configured to determine a timing state associated with the transmission timing of the target uplink signal according to the timing state indication information.

In some embodiments, a same transmission timing is used for uplink signals configured with a same timing state.

In some embodiments, the processing unit 410 is specifically configured to take a transmission timing of an uplink reference signal as a transmission timing of an uplink signal adopting a first timing state in a case where reference signal indicated in the first information is the uplink reference signal.

The first timing state may be a timing state indicated by the timing state indication information in the first information. The uplink signal may include the target uplink signal.

In some embodiments, the processing unit 410 is specifically configured to: in a case where the reference signal indicated in the first information is a downlink reference signal,

determine a first downlink timing according to the downlink reference signal; and determine the transmission timing of the target uplink signal according to the first downlink timing and a timing advance (TA) corresponding to a second timing state.

The second timing state may be a timing state indicated by the timing state indication information in the first information.

In some embodiments, the processing unit is further configured to determine at least one TA corresponding respectively to at least one timing state according to higher layer signaling. The at least one timing state may include the second timing state.

In some embodiments, the terminal device assumes that the transmission timing of the target uplink signal is associated with a timing state 0 in a case where first information does not include timing state indication information.

In some embodiments, a quasi-co-located (QCL) type of the TCI state is one of: a transmission timing, an uplink timing, or a synchronization parameter.

In some embodiments, the TA is obtained based on at least one of a TA offset configured through radio resource control (RRC) signaling, or a TA command indicated through media access control (MAC) layer signaling.

Alternatively, the TA may include at least one of the TA offset configured through the RRC signaling, or the TA command indicated through the MAC layer signaling.

In some embodiments, the downlink reference signal is a channel state information reference signal (CSI-RS) or a synchronization signal block (SSB).

In some embodiments, the communication unit is a communication interface or a transceiver, or an input/output interface of a system on chip or a communication chip. The processing unit may be one or more processors.

Understandably, a terminal device 400 according to an embodiment of the disclosure may correspond to a terminal device in a method embodiment of the disclosure. An above-mentioned operation and/or function and another operation and/or function of a unit in the terminal device 400 is configured to implement a corresponding flow of the terminal device in the method 200 as illustrated in FIG. 7, which is not repeated here for brevity.

FIG. 10 is a block diagram of a network device 500 according to an embodiment of the disclosure. As illustrated in FIG. 10, the network device 500 may include a communication unit.

The communication unit 510 is configured to transmit first information to a terminal device. A reference signal indicated in the first information is configured to be used by the terminal device in determining a transmission timing of a target uplink signal. The first information is a transmission configuration indicator (TCI) state or spatial relation information.

The communication unit 510 is further configured to receive the target uplink signal transmitted by the terminal device according to the transmission timing of the target uplink signal.

In some embodiments, the network device 500 further includes a processing unit 520.

The processing unit 520 is configured to take a reception timing of an uplink reference signal as a reception timing of the target uplink signal in a case where reference signal is the uplink reference signal.

In some embodiments, the network device 500 further includes a processing unit 520.

The processing unit 520 is configured to determine a reception timing of the target uplink signal according to a transmission timing of a downlink reference signal and a timing advance (TA) determined through higher layer signaling in a case where reference signal is the downlink reference signal.

In some embodiments, the TA determined through the higher layer signaling includes multiple TAs of a timing advance group (TAG).

The processing unit 520 is specifically configured to determine the reception timing of the target uplink signal according to the transmission timing of the downlink reference signal and a target TA of the multiple TAs.

In some embodiments, the multiple TAs are in one-to-one correspondence with different control resource set (CORESET) group indexes. The target TA may be a TA corresponding to a CORESET group index associated with the target uplink signal.

Alternatively, the multiple TAs are in one-to-one correspondence with different cell identities (IDs). The target TA is a TA corresponding to a cell ID associated with the target uplink signal.

Alternatively, the multiple TAs are in one-to-one correspondence with different TRPs. The target TA is a TA corresponding to a receiving TRP of the target uplink signal.

In some embodiments, the TA determined through the higher layer signaling includes multiple TAs of a timing advance group (TAG).

The processing unit 520 is specifically configured to determine multiple reception timings of the target uplink signal respectively according to the transmission timing of the downlink reference signal and the multiple TAs.

In some embodiments, the target uplink signal includes a first uplink signal and a second uplink signal. A first reference signal may be indicated in the first information configured for the first uplink signal. A second reference signal may be indicated in the first information configured for the second uplink signal.

The network device 500 may further include a processing unit 520.

The processing unit 520 is configured to determine a first reception timing of the first uplink signal according to the first reference signal. The processing unit is configured to determine a second reception timing of the second uplink signal according to the second reference signal.

The communication unit 510 is specifically configured to receive, respectively according to the first reception timing and the second reception timing, the first uplink signal and the second uplink signal transmitted by the terminal device.

In some embodiments, the first reception timing is different from the second reception timing.

In some embodiments, the first uplink signal and the second uplink signal occupy different time-domain resources, and/or the first uplink signal and the second uplink signal are received through different TRPs.

In some embodiments, in a case where the first uplink signal and the second uplink signal occupy different time-domain resources, and where a time-domain resource occupied by the first uplink signal overlaps a time-domain resource occupied by the second uplink signal due to different transmission timings, the network device does not receive, in an overlapping region, an uplink signal of the first uplink signal and the second uplink signal that comes later in time domain.

In some embodiments, the first information is multiple TCI states or multiple pieces of spatial relation information. The multiple TCI states or the multiple pieces of spatial relation information may indicate multiple reference signals.

The network device 500 may further include a processing unit 520.

The processing unit 520 is configured to determine multiple reception timings of the target uplink signal respectively according to the multiple reference signals.

The communication unit 510 is specifically configured to receive the target uplink signal according to the multiple reception timings of the target uplink signal.

In some embodiments, the processing unit 520 is specifically configured to receive the target uplink signal respectively on different time-domain resources using the multiple reception timings of the target uplink signal.

Alternatively, the processing unit is specifically configured to receive the target uplink signal respectively through different TRPs using the multiple reception timings of the target uplink signal.

In some embodiments, the first information further includes timing state indication information. The timing state indication information is configured to be used by the terminal device in determining a timing state associated with the transmission timing of the target uplink signal.

In some embodiments, a same transmission timing is used for uplink signals configured with a same timing state.

In some embodiments, the network device 500 further includes a processing unit 520 in a case where reference signal indicated in the first information is an uplink reference signal.

The processing unit 520 is configured to take a reception timing of the uplink reference signal as a reception timing of an uplink signal adopting a first timing state. The first timing state may be a timing state indicated by the timing state indication information in the first information. The uplink signal may include the target uplink signal.

In some embodiments, the network device 500 further includes a processing unit 520 in a case where reference signal indicated in the first information is a downlink reference signal.

The processing unit 520 is configured to determine a reception timing of the target uplink signal according to a transmission timing of the downlink reference signal and a timing advance (TA) corresponding to a second timing state. The second timing state may be a timing state indicated by the timing state indication information in the first information.

In some embodiments, the communication unit 510 is further configured to indicate, to the terminal device, at least one TA corresponding respectively to at least one timing state through higher layer signaling. The at least one timing state may include the second timing state.

In some embodiments, the terminal device assumes that the transmission timing of the target uplink signal is associated with a timing state 0 in a case where first information does not include timing state indication information.

In some embodiments, a quasi-co-located (QCL) type of the TCI state is one of:

a transmission timing, an uplink timing, or a synchronization parameter.

In some embodiments, the TA is obtained based on at least one of a TA offset configured through radio resource control (RRC) signaling, or a TA command indicated through media access control (MAC) layer signaling.

Alternatively, the TA may include at least one of the TA offset configured through the RRC signaling, or the TA command indicated through the MAC layer signaling.

In some embodiments, the downlink reference signal is a channel state information reference signal (CSI-RS) or a synchronization signal block (SSB).

In some embodiments, the communication unit is a communication interface or a transceiver, or an input/output interface of a system on chip or a communication chip. The processing unit may be one or more processors.

Understandably, a network device 500 according to an embodiment of the disclosure may correspond to a network device in a method embodiment of the disclosure. An above-mentioned operation and/or function and another operation and/or function of a unit in the network device 500 is configured to implement a corresponding flow of the network device in the method 300 as illustrated in FIG. 8, which is not repeated here for brevity.

FIG. 11 is a schematic structural diagram of a communication device 600 according to an embodiment of the disclosure. The communication device 600 as illustrated in FIG. 11 may include a processor 610. The processor 610 may call and run a computer program in a memory to implement a method in embodiments of the disclosure.

In some embodiments, as illustrated in FIG. 11, the communication device 600 further includes a memory 620. The processor 610 may call and run a computer program in the memory 620 to implement a method in embodiments of the disclosure.

The memory 620 may be a separate device separate from the processor 610, or may be integrated in the processor 610.

In some embodiments, as illustrated in FIG. 11, the communication device 600 further includes a transceiver 630. The processor 610 may control communication by the transceiver 630 with another device. Specifically, the transceiver transmits information or data to the other device, or receives information or data transmitted by the other device.

The transceiver 630 may include a transmitter and a receiver. The transceiver 630 may further include one or more antennas.

In some embodiments, the communication device 600 is a network device according to embodiments of the disclosure, and the communication device 600 implements a corresponding flow implemented by a network device in a method according to embodiments of the disclosure, which is not repeated here for brevity.

In some embodiments, the communication device 600 is a terminal device according to embodiments of the disclosure, and the communication device 600 implements a corresponding flow implemented by a terminal device in a method according to embodiments of the disclosure, which is not repeated here for brevity.

FIG. 12 is a schematic structural diagram of an apparatus according to an embodiment of the disclosure. The apparatus 700 as illustrated in FIG. 12 may include a processor 710. The processor 710 may call and run a computer program in a memory to implement a method in embodiments of the disclosure.

In some embodiments, as illustrated in FIG. 12, the apparatus 700 further includes a memory 720. The processor 710 may call and run a computer program in the memory 720 to implement a method in embodiments of the disclosure.

The memory 720 may be a separate device separate from the processor 710, or may be integrated in the processor 710.

In some embodiments, the apparatus 700 further includes an input interface 730. The processor 710 may control communication by the input interface 730 with another device or chip. Specifically, information or data transmitted by the other device or chip are acquired.

In some embodiments, the apparatus 700 further includes an output interface 740. The processor 710 may control communication by the output interface 740 with another device or chip. Specifically, information or data are output to the other device or chip.

In some embodiments, the apparatus applies to a network device in embodiments of the disclosure, and the apparatus implements a flow implemented by a network device in a method according to embodiments of the disclosure, which is not repeated here for brevity.

In some embodiments, the apparatus applies to a terminal device in embodiments of the disclosure, and the apparatus implements a flow implemented by a terminal device in a method according to embodiments of the disclosure, which is not repeated here for brevity.

In some embodiments, an apparatus mentioned in embodiments of the disclosure may also be a chip, such as a system-level chip, a system chip, a chip system, a SOC chip, etc.

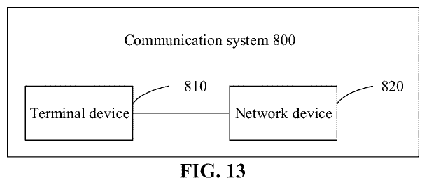

FIG. 13 is a block diagram of a communication system 800 according to an embodiment of the disclosure. As illustrated in FIG. 13, the communication system 800 may include a terminal device 810 and a network device 820.

The terminal device 810 may be configured to implement a corresponding function implemented by a terminal device in a method herein, and the network device 820 may be configured to implement a corresponding function implemented by a network device in a method herein, which is not repeated here for brevity.

Note that a processor according to embodiments of the disclosure may be an integrated circuit chip capable of signal processing. In implementation, a step of a method embodiment herein may be carried out via an integrated logic circuit of hardware in the processor or instructions in form of software. The processor may be a general-purpose processor, a digital signal processor (DSP), an application specific integrated circuit (ASIC), a field programmable gate array (FPGA), or another programmable logic device, a discrete gate, or a transistor logic device, a discrete hardware component, etc. The processor may implement or execute various methods, steps, and logical block diagrams according to embodiments of the disclosure. A general-purpose processor may be a microprocessor or any conventional processor. A step of the method disclosed in embodiments of the disclosure may be directly embodied as being carried out by a hardware decoding processor, or by a combination of hardware and software modules in the decoding processor. A software module may be located in a mature storage medium in the art, such as a random access memory (RAM), a flash memory, a read only memory (ROM), a programmable read-only memory (PROM), an electrically rewritable programmable memory, a register, etc. The storage medium may be located in the memory. The processor may read information in the memory, and combine it with hardware of the processor to perform a step of a method herein.

Understandably, a memory in embodiments of the disclosure may be a volatile and/or a non-volatile memory. The non-volatile memory may be a read-only memory (ROM), a programmable ROM (PROM), an erasable PROM (EPROM), an electrically EPROM (EEPROM), or a flash memory, etc. The volatile memory may be a random access memory (RAM) serving as an external cache. By way of illustrative instead of restrictive description, there are many forms of RAM available, such as a static RAM (SRAM), a dynamic RAM (DRAM), a synchronous DRAM (SDRAM), a double data rate SDRAM (DDR SDRAM), an enhanced SDRAM (ESDRAM), a synchlink DRAM (SLDRAM), a direct rambus RAM (DR RAM), etc. Note that a memory of a system and method described herein is intended to include, but is not limited to, these and any other memory of suitable types.

Understandably, a foregoing memory is described in an illustrative nonrestrictive way. For example, a memory in embodiments of the disclosure may also be a static RAM (SRAM), a dynamic RAM (DRAM), a synchronous DRAM (SDRAM), a double data rate SDRAM (DDR SDRAM), an enhanced SDRAM (ESDRAM), a synch link DRAM (SLDRAM), a direct rambus RAM (DR RAM), etc. That is, a memory in embodiments of the disclosure is intended to include, but is not limited to, these and any other memory of suitable types.

Embodiments of the disclosure further provide a computer-readable storage medium configured to store a computer program.

In some embodiments, the computer-readable storage medium may be applied to a network device in embodiments of the disclosure, and the computer program allows a computer to execute a corresponding flow implemented by a network device in a method according to an embodiment of the disclosure, which is not repeated here for brevity.

In some embodiments, the computer-readable storage medium may be applied to a terminal device in embodiments of the disclosure, and the computer program allows a computer to execute a corresponding flow implemented by a terminal device in a method according to an embodiment of the disclosure, which is not repeated here for brevity.

Embodiments of the disclosure further provide a computer program product including computer program instructions.

In some embodiments, the computer program product may be applied to a network device in embodiments of the disclosure, and the computer program instructions allows a computer to execute a corresponding flow implemented by a network device in a method according to an embodiment of the disclosure, which is not repeated here for brevity.

In some embodiments, the computer program product may be applied to a terminal device in embodiments of the disclosure, and the computer program instructions allows a computer to execute a corresponding flow implemented by a terminal device in a method according to an embodiment of the disclosure, which is not repeated here for brevity.

Embodiments of the disclosure further provide a computer program.

In some embodiments, the computer program may be applied to a network device in embodiments of the disclosure. When being run on a computer, the computer program allows the computer to execute a corresponding flow implemented by a network device in a method according to an embodiment of the disclosure, which is not repeated here for brevity.

In some embodiments, the computer program may be applied to a terminal device in embodiments of the disclosure. When being run on a computer, the computer program allows the computer to execute a corresponding flow implemented by a terminal device in a method according to an embodiment of the disclosure, which is not repeated here for brevity.

A person having ordinary skill in the art may realize that a unit and an algorithm step in an example according to embodiments of the disclosure may be implemented by electronic hardware or a combination of electronic hardware and computer software. Whether such a function is implemented by hardware or by software depends on a specific application of a technical solution as well as a design constraint. Depending on a specific application, a person having ordinary skill in the art may implement a described function using different methods. Such implementations however should not be deemed going beyond a scope of the disclosure.

A person having ordinary skill in the art will clearly understand that, for convenience and conciseness of description, reference may be made to a corresponding process in a foregoing method embodiment for a detailed working process of a system, an apparatus, a unit, etc., described above, which is not repeated here.

In a number of embodiments provided in the disclosure, it should be understood that a method, an apparatus, a system, etc., as disclosed, may be implemented in other ways. For example, a described apparatus embodiment is merely illustrative. For example, division of units is merely logic function division and there may be another division in actual implementation. For example, units or components may be combined, or integrated into another system, or some features/characteristics may be omitted or skipped. Furthermore, the coupling, or direct coupling or communicational connection illustrated or discussed herein may be implemented through indirect coupling or communicational connection among some interfaces, apparatuses, or units, and may be electrical, mechanical, or of another form.

The units described as separate components may or may not be physically separated. Components shown as units may be or may not be physical units. They may be located in one place, or distributed on multiple network units. Some or all of the units may be selected to achieve the purpose of a solution of the embodiments as needed.

In addition, functional units in embodiments of the disclosure may be integrated in one processing part, or exist as separate physical units respectively. Alternatively, two or more units may be integrated in one unit.

When implemented in form of a software functional unit and sold or used as an independent product, the function may be stored in a computer-readable storage medium. Based on such an understanding, the essential part or a part contributing to prior art of the technical solution of the disclosure or part of the technical solution may appear in form of a software product. The software product is stored in a storage medium, and includes a number of instructions for allowing computer device (such as a personal computer, a server, network device, etc.) to execute all or part of a method in an embodiment of the disclosure. The storage medium includes various media that may store program codes, such as a U disk, a mobile hard disk, Read-Only Memory (ROM), Random Access Memory (RAM), a magnetic disk, a CD, etc.

What described are just embodiments of the disclosure and are not intended to limit the scope of the disclosure. Any modification, equivalent replacement, and/or the like made within the technical scope of the disclosure, as may occur to a person having ordinary skill in the art, shall be included in the scope of the disclosure. The scope of the disclosure thus should be determined by the claims.

1. A method for wireless communication, comprising:
determining, by a terminal device, a transmission timing of a target uplink signal according to a reference signal indicated in first information configured for the target uplink signal, the first information being a transmission configuration indicator (TCI) state or spatial relation information; and
transmitting, by the terminal device, the target uplink signal according to the transmission timing of the target uplink signal.

2. The method of claim 1, wherein the reference signal is an uplink reference signal,
wherein determining, by the terminal device, the transmission timing of the target uplink signal according to the reference signal indicated in the first information configured for the target uplink signal comprises:
taking, by the terminal device, a transmission timing of the uplink reference signal as the transmission timing of the target uplink signal.

3. The method of claim 1, wherein the reference signal is a downlink reference signal,
wherein determining, by the terminal device, the transmission timing of the target uplink signal according to the reference signal indicated in the first information configured for the target uplink signal comprises:
determining, by the terminal device, a first downlink timing according to the downlink reference signal; and
determining, by the terminal device, the transmission timing of the target uplink signal according to the first downlink timing and a timing advance (TA) determined through higher layer signaling.

4. The method of claim 3, wherein the TA determined through the higher layer signaling comprises multiple TAs of a timing advance group (TAG),
wherein determining, by the terminal device, the transmission timing of the target uplink signal according to the first downlink timing and the TA determined through the higher layer signaling comprises:
determining, by the terminal device, the transmission timing of the target uplink signal according to the first downlink timing and a target TA of the multiple TAs.

5. The method of claim 4, wherein
the multiple TAs are in one-to-one correspondence with different control resource set (CORESET) group indexes, and the target TA is a TA corresponding to a CORESET group index associated with the target uplink signal; or
the multiple TAs are in one-to-one correspondence with different cell identities (IDs), and the target TA is a TA corresponding to a cell ID associated with the target uplink signal.

6. The method of claim 3, wherein the TA determined through the higher layer signaling comprises multiple TAs of a TAG,
wherein determining, by the terminal device, the transmission timing of the target uplink signal according to the first downlink timing and the TA determined through the higher layer signaling comprises:
respectively determining, by the terminal device, multiple transmission timings of the target uplink signal according to the first downlink timing and the multiple TAs.

7. A terminal device, comprising:
a processor, a memory and a transceiver, wherein the memory is configured to store computer-executable instructions; and the processor is configured to invoke and run the computer-executable instructions stored in the memory to perform operations of:
determining a transmission timing of a target uplink signal according to a reference signal indicated in first information configured for the target uplink signal, the first information being a transmission configuration indicator (TCI) state or spatial relation information; and
transmitting, through the transceiver, the target uplink signal according to the transmission timing of the target uplink signal.

8. The terminal device of claim 7, wherein the reference signal is an uplink reference signal,
wherein determining the transmission timing of the target uplink signal according to the reference signal indicated in the first information configured for the target uplink signal comprises:
taking a transmission timing of the uplink reference signal as the transmission timing of the target uplink signal.

9. The terminal device of claim 7, wherein the reference signal is a downlink reference signal,
wherein determining the transmission timing of the target uplink signal according to the reference signal indicated in the first information configured for the target uplink signal comprises:
determining a first downlink timing according to the downlink reference signal; and
determining the transmission timing of the target uplink signal according to the first downlink timing and a timing advance (TA) determined through higher layer signaling.

10. The terminal device of claim 9, wherein the TA determined through the higher layer signaling comprises multiple TAs of a timing advance group (TAG),
wherein determining the transmission timing of the target uplink signal according to the first downlink timing and the TA determined through the higher layer signaling comprises:
determining the transmission timing of the target uplink signal according to the first downlink timing and a target TA of the multiple TAs.

11. The terminal device of claim 7, wherein the target uplink signal comprises a first uplink signal and a second uplink signal, wherein a first reference signal is indicated in the first information configured for the first uplink signal, and a second reference signal is indicated in the first information configured for the second uplink signal,
wherein determining the transmission timing of the target uplink signal according to the reference signal indicated in the first information configured for the target uplink signal comprises:
determining a first transmission timing of the first uplink signal according to the first reference signal, and determining a second transmission timing of the second uplink signal according to the second reference signal, and
wherein transmitting, through the transceiver, the target uplink signal according to the transmission timing of the target uplink signal comprises
respectively transmitting, through the transceiver, the first uplink signal and the second uplink signal according to the first transmission timing and the second transmission timing.

12. The terminal device of claim 7, wherein the first information further comprises timing state indication information,
wherein the processor is configured to invoke and run the computer-executable instructions to further perform an operation of
determining a timing state associated with the transmission timing of the target uplink signal according to the timing state indication information.

13. The terminal device of claim 12, wherein a same transmission timing is used for uplink signals configured with a same timing state.

14. A network device, comprising:
a processor, a memory and a transceiver, wherein the memory is configured to store computer-executable instructions; and the processor is configured to invoke and run the computer-executable instructions stored in the memory to perform operations of:
transmitting, through the transceiver, first information to a terminal device, wherein a reference signal indicated in the first information is configured to be used by the terminal device in determining a transmission timing of a target uplink signal, the first information being a transmission configuration indicator (TCI) state or spatial relation information; and
receiving, through the transceiver, the target uplink signal transmitted by the terminal device according to the transmission timing of the target uplink signal.

15. The network device of claim 14, wherein the processor is configured to invoke and run the computer-executable instructions to further perform an operation of:
in a case where the reference signal is an uplink reference signal, taking a reception timing of an uplink reference signal as a reception timing of the target uplink signal.

16. The network device of claim 14, wherein the first information further comprises timing state indication information, wherein the timing state indication information is configured to be used by the terminal device in determining a timing state associated with the transmission timing of the target uplink signal.

17. The network device of claim 16, wherein the processor is configured to invoke and run the computer-executable instructions to further perform an operation of: in a case where the reference signal indicated in the first information is an uplink reference signal,
taking a reception timing of an uplink reference signal as a reception timing of an uplink signal adopting a first timing state, wherein the first timing state is a timing state indicated by the timing state indication information in the first information, and the uplink signal comprises the target uplink signal.

18. The network device of claim 16, wherein the processor is configured to invoke and run the computer-executable instructions to further perform an operation of: in a case where the reference signal indicated in the first information is a downlink reference signal,
determining a reception timing of the target uplink signal according to a transmission timing of a downlink reference signal and a timing advance (TA) corresponding to a second timing state, wherein the second timing state is a timing state indicated by the timing state indication information in the first information.

19. The network device of claim 18, wherein the processor is configured to invoke and run the computer-executable instructions to further perform an operation of:
indicating, to the terminal device, at least one TA corresponding respectively to at least one timing state through higher layer signaling, wherein the at least one timing state comprises the second timing state.

20. A non-transitory computer-readable storage medium having stored thereon computer-executable instructions which, when executed by a processor, causes the processor to perform the method of claim 1.
